(19) United States
(12) Patent Application Publication
(10) Pub. No.: US 2014/0052520 A1
(43) Pub. Date: Feb. 20, 2014

(54) System and Method for Coordinating Purchases of Goods and Services

(71) Applicant: Aubrey J. Wooddy, III, Mount Pleasant, SC (US)

(72) Inventor: Aubrey J. Wooddy, III, Mount Pleasant, SC (US)

(21) Appl. No.: 13/677,838

(22) Filed: Nov. 15, 2012

Related U.S. Application Data
(60) Provisional application No. 61/691,139, filed on Aug. 20, 2012.

(51) Int. Cl. G06Q 30/06

(52) U.S. Cl. CPC G06Q 30/0605; G06Q 30/0207
USPC 705/14.23; 705/14.16; 705/14.26; 705/14.25

(57) ABSTRACT

A method for coordinating purchases of goods or services comprises the steps of establishing a consumer group (216) including a plurality of members (218A-218n); and establishing a first price discount on a first consumable that is made available to each of the plurality of members (218A-218n) of the consumer group, the first price discount being based on the number of members (218A-218n) in the consumer group (216). The step of establishing a first price discount can include the first price discount being made available to each of the plurality of members (218A-218n) of the consumer group (216) regardless of the number of members (218A-218n) that actually purchase the first consumable. The method can further comprise the step of providing a rebate to a first member (218A) of the consumer group (216), the rebate being based upon a dollar amount of purchases made by one or more members (218A-218n) of the consumer group (216) over a predetermined period of time.

### RELATED INVENTION

This application claims domestic priority under 35 U.S.C. §119(e) on U.S. Provisional Patent Application Ser. No. 61/691,139 filed on Aug. 20, 2012, entitled “METHOD FOR CONDUCTING MERCHANDISE OR SERVICE SALES”. As far as is permitted, the contents of U.S. Provisional Patent Application Ser. No. 61/691,139 are incorporated herein by reference.

### BACKGROUND

Providers of goods and/or services desire to promote loyalty among their consumers so that the consumers continue to use their goods and/or services. In some instances, consumers have established network marketing systems (also referred to as multi-level marketing systems) whereby the providers use a coordinated marketing and distribution system that rewards marketers/distributors for getting others involved in the marketing system.

Additionally, consumers desire to have a system whereby they can receive incentives for purchasing goods and/or services from particular providers. For example, consumers often desire to receive price discounts, rebates and/or other incentives based on the purchases that they make. Further, consumers are sometimes able to get together in co-ops or buying groups in order to increase their purchasing power or leverage relative to the providers.

### SUMMARY

The present invention is directed to a method for coordinating purchases of goods or services. In certain embodiments, the method comprises the steps of establishing a consumer group including a plurality of members; and establishing a first price discount on a first consumable that is made available to each of the plurality of members of the consumer group, the first price discount being based on the number of members in the consumer group.

In one embodiment, the step of establishing a first price discount includes the first price discount being made available to each of the plurality of members of the consumer group regardless of the number of members that actually purchase the first consumable.

Additionally, in one embodiment, the method can further comprise the step of applying the first price discount to a rewardable purchase of the first consumable made by a first member.

In one embodiment, the method further comprises the step of establishing a second price discount on a second consumable that is made available to a first member of the consumer group, wherein the second price discount on the second consumable is not made available to a second member of the consumer group.

The method can further comprise the step of providing a rebate to a first member of the consumer group, the rebate being based upon a dollar amount of purchases made by one or more members of the consumer group over a predetermined period of time. Additionally and/or alternatively, the method can further comprise the step of providing a rebate to a first member of the consumer group, the rebate being based upon a number of purchases made by one or more members of the consumer group over a predetermined period of time.

In some embodiments, the method further comprises the step of providing a first rebate to a first member of the consumer group when any member of the consumer group makes a first rewardable purchase. In one such embodiment, the method further comprises the step of providing a second rebate to the first member of the consumer group when any member of the consumer group makes a second rewardable purchase.

Additionally, in certain embodiments, the step of establishing a consumer group includes the step of a first member originating the consumer group by making a first qualified purchase. In one such embodiment, the step of establishing a consumer group further includes the step of adding a second member to the consumer group when the second member makes a second qualified purchase.

Further, in some embodiments, the step of establishing a consumer group includes the step of a first member originating the consumer group by registering an initialization code with a system administrator. In one such embodiment, the step of establishing a consumer group includes the first member receiving the initialization code when the first member makes a qualified purchase. In another such embodiment, the step of establishing a consumer group further includes the step of adding a second member to the consumer group when the second member registers the initialization code with the system administrator. In still another such embodiment, the step of establishing a consumer group further includes the step of adding a second member to the consumer group when the second member receives the initialization code from the first member and registers an associated code with the system administrator, the associated code being associated with the initialization code.

Additionally, in one embodiment, the present invention is directed to a method for coordinating purchases of goods or services, the method comprising the steps of establishing a consumer group including at least a first member and a second member, the consumer group being established by (i) the first member registering an initializing code with a system administrator, (ii) the second member receiving the initialization code from the first member, and (ii) the second member registering the initialization code with the system administrator; and establishing a price discount on a first consumable that is made available to the first member and the second member of the consumer group, the price discount being based on the number of members in the consumer group.

Further, in one embodiment, the present invention is directed to a method for coordinating purchases of goods or services, the method comprising the steps of establishing a consumer group including at least a first member and a second member, the consumer group being established by (i) the first member making a qualified purchase, and (ii) the second member making a subsequent qualified purchase; and establishing a price discount on a first consumable that is made available to the first member and the second member of the consumer group, the price discount being based on the number of members in the consumer group.

Additionally, in one embodiment, the present invention is directed to a sales system for coordinating purchases of goods or services, the sales system comprising a consumer group including a plurality of members; and a system administrator that coordinates the purchases of goods and services for the consumer group, the system administrator establishing a first price discount on a first consumable that is made available to each of the plurality of members of the consumer group, the first price discount being based on the number of members in the consumer group.

Still further, in one embodiment, the present invention is directed to a sales system for coordinating purchases of goods or services, the sales system comprising a consumer group including at least a first member and a second member, the first member receiving an initialization code and forwarding the initialization code to the second member; and a system administrator that coordinates the purchases of goods and services for the consumer group, the first member and the second member registering the initialization code with the system administrator, wherein the system administrator establishes a first price discount on a first consumable that is made available to each of the plurality of members of the consumer group, the first price discount being based on the number of members in the consumer group.

Yet further, in one embodiment, the present invention is also directed to a sales system for coordinating purchases of goods or services, the sales system comprising a consumer group including at least a first member and a second member, the consumer group being established by (i) the first member making a qualified purchase, and (ii) the second member making a subsequent qualified purchase; and a system administrator that coordinates the purchases of goods and services for the consumer group, wherein the system administrator establishes a first price discount on a first consumable that is made available to each of the plurality of members of the consumer group, the first price discount being based on the number of members in the consumer group.

### BRIEF DESCRIPTION OF THE DRAWINGS

The novel features of this invention, as well as the invention itself, both as to its structure and its operation, will be best understood from the accompanying drawings, taken in conjunction with the accompanying description in which similar reference characters refer to similar parts, and in which:

FIG. 1 is a simplified schematic illustration of an embodiment of a sales system having features of the present invention, the sales system including a system administrator, one or more providers, and one or more consumer groups;

FIG. 2 is a simplified schematic illustration of one non-exclusive example of a consumer group that can operate within the sales system of FIG. 1;

FIG. 3 is a flow chart illustrating the operation of one embodiment of the sales system having features of the present invention; and

FIG. 4 is a flow chart illustrating the operation of another embodiment of the sales system having features of the present invention.

### DESCRIPTION

As an overview, the present invention is directed toward a system and method for coordinating purchases or expenditures of goods and/or services involving one or more individuals. It should be noted that any goods and/or services may be referred to herein generally as “consumables”. In certain embodiments, and as described in greater detail herein, multiple individuals (also referred to herein as “members” or “consumers”) can associate themselves with one another into a “consumer group” in order to more effectively coordinate any purchases or expenditures from providers who choose to make one or more of their goods and/or services available to the system. Additionally, in various embodiments, the members can include end consumers, wholesalers, retailers, distributors, or any other person or entity in the chain of commerce. Further, the merchandise and/or service purchases or expenditures can occur via any suitable method or methods. For example, in one embodiment, the purchases of merchandise and/or services occur over the Internet, e.g., online. Additionally and/or alternatively, the purchases can occur by other suitable methods, such as in-person purchases made at consumer stores, outlets, kiosks or other suitable locations. Further, the purchases can also occur by such other methods as “door-to-door” sales, telephone sales, mail-order sales or any other suitable method that allows the consumers to purchase any type of goods or services. As used herein, it is understood that the terms “purchase” and “sale” relate to either or both of goods or services, unless otherwise specified.

Additionally, as provided in detail herein, certain specified benefits, e.g., price discounts (sometimes simply referred to as “discounts”), rebates, etc., can be available to the consumers based on purchases made by themselves and/or by one or more additional associated consumers, i.e. by any members of a given individual's consumer group. Further, in certain embodiments, the specified benefits can be made available to the individual members within the consumer group regardless of the number of members within the consumer group that ultimately choose to take advantage of the specified benefits, i.e. that ultimately choose to make any applicable purchases. Moreover, the certain specified benefits can be based, at least in part, on the number of members in the consumer group, the number of purchases made by members of the consumer group, and/or the sales volume, i.e. dollar value, of the purchases made by members of the consumer group. Additionally and/or alternatively, such specified benefits can also be based on other factors related to the consumers, the consumer group, and/or the providers.

It is recognized that the specific examples that are provided herein below are provided for ease of understanding only, and that an infinite number of reward (price discount, rebate, etc.) structures are possible that demonstrate the features of the present invention. Additionally, it is further recognized that the number of consumers in the consumer group and/or the total amount of the purchases required to trigger a particular reward, i.e. a particular percentage discount or a particular percentage rebate, can be greater or fewer than those provided in the specific examples illustrated herein. Somewhat similarly, the specific rewards (percentage discounts, percentage rebates, etc.) can be varied depending upon the number of members in the consumer group, the number of purchases made by members of the consumer group, or the total amount of the purchases made by members of the consumer group, and such rewards can include percentages that are lower than or higher than those included in the various examples specifically recited herein.

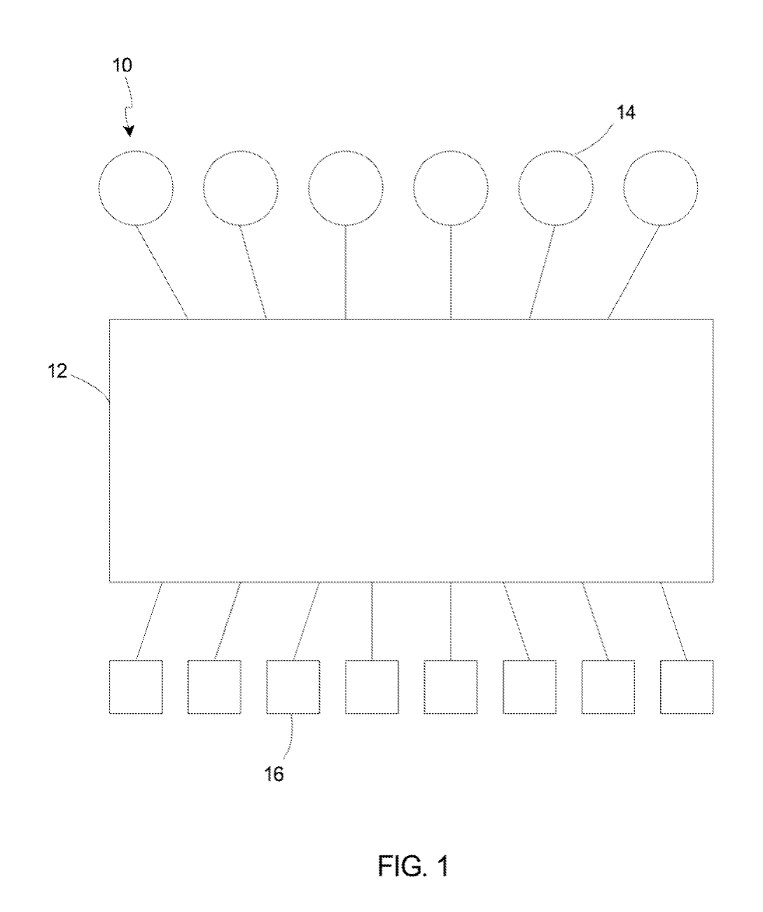

FIG. 1 is a simplified schematic illustration of an embodiment of a sales system 10 having features of the present invention. The design of the sales system 10 can be varied. As shown in the embodiment illustrated in FIG. 1, the sales system 10 can include a system administrator 12, one or more providers 14 of goods and/or services, and one or more consumer groups 16. In the embodiment illustrated in FIG. 1, the sales system 10 includes six providers 14 (represented by circles) and eight consumer groups 16 (represented by squares), although it should be noted that the specific number of providers 14 and/or consumer groups 16 can include any suitable number as long as there is at least one provider 14 and at least one consumer group 16 included in the sales system 10.

The system administrator 12 coordinates the sales and purchases that are made by and between the providers 14 and the consumer groups 16 within the sales system 10. Additionally, the system administrator 12 can actively promote the sales system 10 and/or recruit or otherwise coordinate individual providers 14 and individual consumers or consumer groups 16 to participate, e.g., become members, in the sales system 10. In certain embodiments, the system administrator 12 can include one or more individuals, computers, servers, databases, record books, etc. that cooperate to administer, coordinate, monitor, determine and/or arrange the specific terms and conditions as agreed upon within the sales system 10. More particularly, the system administrator 12 can record, facilitate, track and/or manage any purchases that may be made though the sales system 10. Further, the system administrator 12 can increase the likelihood and/or ensure that any specified rewards that are earned through an activity within the sales system 10, i.e. purchases and/or sales, are passed on to or otherwise made available to the consumer groups 16 as specified or required by the terms and conditions specified in the sales system 10.

In one embodiment, the providers 14 (as utilized herein, a “provider” can be a manufacturer, distributor, service provider, etc., or anyone who otherwise makes a good or service available to the consuming public) can agree to make one or more of their products and/or services available for purchase and/or use through the sales system 10. For example, in various non-exclusive embodiments, e.g., in different sales systems 10, the providers 14 can choose to make some or all of their products and/or services available for purchase through the sales system 10. Moreover, in certain alternative embodiments, the providers 14 can choose to make some or all of their products and/or services subject to one or more of the various terms incorporated within the sales system 10. For example, the providers 14 can choose to make certain products and/or services available for purchase through the sales system 10 in order to (i) enable a given consumer to formally enter a consumer group, (ii) enable a given consumer to receive a specified discount via the terms of the sales system 10, (iii) enable a given consumer to receive a specified rebate via the terms of the sales system 10, and/or (iv) enable the consumer to receive other specified rewards or benefits associated with the sales system 10.

It should be noted that purchases made to enable a given consumer to formally enter a consumer group (item (i) above) are sometimes referred to generally herein as “qualified purchases”. Additionally, it should also be noted that purchases made to enable a given consumer to receive specified discounts, rebates and/or other rewards (items (ii) through (iv) above) are sometimes referred to herein generally as “rewardable purchases”.

In certain embodiments, the specific products and/or services made available for purchase through the sales system 10 by the providers 14 can be selectively usable within the sales system 10 for one or more of the aspects noted in items (i)-(iv) above. For example, in some embodiments, certain products and/or services made available for purchase through the sales system 10 may be usable only for enabling a given consumer to formally enter a consumer group, and not for the purpose of enabling the consumer to receive a specified discount, rebate or other reward. Stated another way, in some embodiments, certain products and/or services made available for purchase through the sales system 10 may be usable only as a qualified purchase and not as a rewardable purchase. Additionally and/or alternatively, certain other products made available for purchase through the sales system 10 may be usable not only for enabling a given consumer to formally enter a consumer group, but also for the purpose of enabling the consumer to receive one or more of a specified discount, a specified rebate, and/or any other specified reward. Stated in another fashion, certain products and/or services made available for purchase through the sales system 10 may be usable as both a qualified purchase and as one or more types of rewardable purchase. Further, in one embodiment, still certain other products made available for purchase through the sales system 10 may be usable only as one or more types of rewardable purchase, but cannot be usable as a qualified purchase.

The consumer groups 16 selectively make purchases of the available goods and/or services through the sales system 10, e.g., qualified purchases and/or rewardable purchases. Each of the consumer groups 16 consists of one or more individuals that join together, as described in greater detail below, to use the sales system 10 to provide a means for generating and/or receiving rewards, e.g., discounts, rebates, etc., or reward offerings related to the purchases of products and/or services from the providers 14 that have been made available to and/or through the sales system 10. It should be noted that any purchases made by the consumer groups 16 through the sales system 10 can be made directly from the providers 14 or they may be made indirectly from the providers 14, e.g., via the sales administrator 12 or in some other suitable indirect manner.

In some embodiments, as provided herein, the specific rewards made available to the consumer groups 16 can be based upon one or more variables related to the consumer group 16 and/or to the activities of the consumer group 16. For example, in certain embodiments, the specific amount or extent of any rewards that become available to the consumer groups 16 through the sales system 10 can be based on one or more of (i) the number of individual consumers included within the consumer group 16 at the time of the rewardable purchase (regardless of whether the consumer(s) in the consumer group 16 actually participated in the rewardable purchase); (ii) the dollar value of purchases made by members of the consumer group 16 through the sales system 10 within a certain period of time, e.g., within the previous month; and/or (iii) the number of individual purchases made by members of the consumer group 16 through the sales system 10 within a certain time period, e.g. within the previous week, month, quarter, etc. Additionally and/or alternatively, the specific rewards can be based on other factors or variables related to the consumer group 16 (including the purchase activities of the consumer group 16), and/or the specific rewards can be based, at least in part, upon factors or variables not directly related to the consumer group 16.

Moreover, in some embodiments, certain rewards, e.g., specific price discounts, are made available to all members within the consumer group 16, regardless of the individual member's position, status or level within the consumer group 16. Further, such rewards can be made available to all members within the consumer group 16, regardless of how many members of the consumer group 16 ultimate make such a rewardable purchase. Additionally and/or alternatively, the rewards made available to the various members of the consumer group 16 may vary depending on the individual member's position, status or level within the consumer group 16.

Further, the rewards provided or otherwise made available to the consumer group 16 can vary depending on the specific products or services that are purchased by members of the consumer group 16, even if such purchases are made from the same provider 14. For example, for a consumer group 16 of 250 individuals, some or all of the members of the consumer group 16 can receive: (a) a 5% discount for the purchase of product A from a first provider; (b) a 10% discount for the purchase of product B from the first provider; (c) an 8% discount for the purchase of service C from a second provider; (d) a 10% discount for the purchase of service D from the second provider, or any other suitable discount percentage can be used. Additionally and/or alternatively, some or all of the members of the consumer group 16 can receive a certain specified price discount, e.g., 5%, 10% or some other percent discount, based on the number of members in the consumer group 16, with the certain specified price discount being available and/or applicable to all purchases made by members of the consumer group 16 through the sales system 10.

It is recognized that the percentages provided in the above examples are provided for ease in understanding only, and that any suitable percentages for any of the products can be used, whether they are the same or different from one another. It is further recognized that the discount percentages can vary depending upon the number of members in the consumer group 16, and that the size of the consumer group 16 in this example is provided for ease in understanding only, and is not intended to limit the scope of the invention in any manner. Any number of members can be included in any particular consumer group 16.

In another example, for a consumer group 16 that purchased $100,000 worth of products during a preceding definite period, e.g., during the previous month, one or more members of the consumer group 16 can receive, as non-exclusive examples: (a) a 5% rebate for any rewardable purchases of product A from the first provider in the preceding definite period (e.g., within the preceding week, month, quarter, etc.); (b) a 10% discount for the rewardable purchase of product A from the first provider in the present period (e.g., within the present week, month, quarter, etc.); (c) an 8% rebate for the any rewardable purchases of service C from the second provider in the preceding definite period; (d) a 10% discount for the rewardable purchase of service D from the second provider in the present period or any other suitable discount percentage can be used.

The number of members (or individuals) within a consumer group 16 can vary depending on the specific desires or actions of the members of the consumer group 16, and/or can be limited based on the specific rules of the sales system 10. For example, the consumer group 16 can function with only a single member, or the consumer group 16 can function with more than one member. Generally speaking, as demonstrated in particular examples provided herein, it may be advantageous to have as many members as possible within a given consumer group 16 (at least to a point), as the specific rewards, i.e. discounts, rebates, etc., available to the members of the consumer group 16 can increase as the number of members in the consumer group 16 increases, and/or as the total volume of purchases made by the consumer group 16 increases. It should be noted that a limit or cap can be placed on any and all available rewards, e.g., price discounts, rebates, etc., that may be made available to any and all members of the consumer group 16.

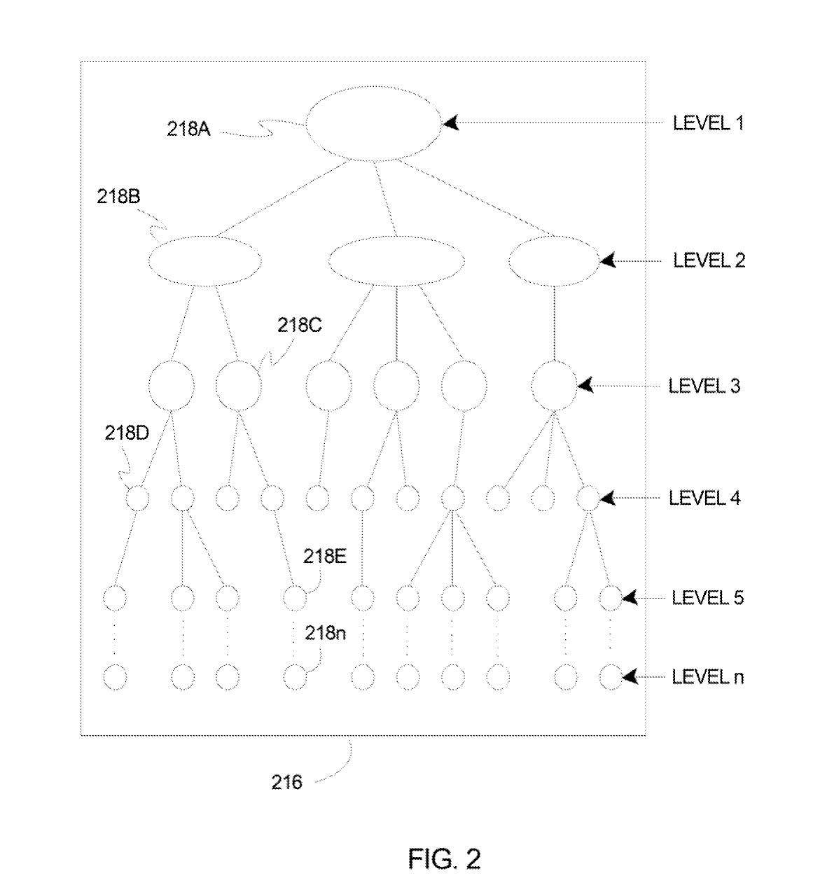

FIG. 2 is a simplified schematic illustration of one non-exclusive example of a consumer group 216 that can operate within the sales system 10 of FIG. 1. As illustrated, the consumer group 216 can have a generally hierarchical or pyramidal structure having any suitable number of levels, i.e. can have n levels of consumers, which can be based on how or when individual members are invited into and/or enter the consumer group 216. Stated in another fashion, in certain embodiments, the consumer group 216 can include one or more Level 1 consumers 218A, one or more Level 2 consumers 218B, one or more Level 3 consumers 218C, one or more Level 4 consumers 218D, one or more Level 5 consumers 218E, etc. up to and including one or more Level n consumers 218n. Alternatively, the consumer group 216 can exclude one or more of Level 2 consumers 218B, Level 3 consumers 218C, Level 4 consumers 218D, Level 5 consumers 218E, etc. up to and including Level n consumers 218n.

In the particular example illustrated in FIG. 2, the consumer group 216 includes one Level 1 consumer 218A, three Level 2 consumers 218B, six Level 3 consumers 218C, eleven Level 4 consumers 218D, ten Level 5 consumers 218E, and ten Level n consumers 218n. In certain embodiments, there can be only one Level 1 consumer 218A. In alternative embodiments, there can be any number of Level 1 consumers 218A. In various embodiments, the number of Level 2 consumers 218B, Level 3 consumers 218C, Level 4 consumers 218D, Level 5 consumers 218E, etc. up to and including Level n consumers 218n, can include any number of members depending on the specific desires and actions of the other members of the consumer group 216. Alternatively, the number of Level 2 consumers 218B, Level 3 consumers 218C, Level 4 consumers 218D, Level 5 consumers 218E, etc. up to and including Level n consumers 218n, can be limited or restricted.

It should further be noted that the specified discounts, rebates and other rewards or benefits available for the members of the consumer group 216 can vary depending on the level of the consumers within the consumer group 216. For example, in different embodiments, the Level 1 consumers 218A may be entitled to greater rewards than the lower level consumers (such as Level 2, Level 3, Level 4, etc.), or the Level 1 consumers 218A may be entitled to the same rewards as the lower level consumers. In one non-exclusive embodiment provided for ease of understanding only, for any given product or service rewardable purchase within the consumer group, the Level 1 consumer 218A may be entitled to a 10% discount, the Level 2 consumers 218B may be entitled to a 9% discount, the Level 3 consumers 218C and Level 4 consumers 218D may be entitled to an 8% discount, and any Level 5 consumers 218E and below may be entitled to a 7% discount. Alternatively, in another non-exclusive embodiment provided for ease of understanding only, for any given product or service rewardable purchase within the consumer group 216, all consumers (regardless of level within the consumer group 216) may be entitled to an 8% discount.

The manner in which the consumer group 216 is established and developed, and the manner in which individual members are assigned to different levels within the consumer group 216 can be varied. For example, in certain embodiments, individual members are assigned to different levels within the consumer group 216 depending on how they were invited into and/or entered into the consumer group 216. In one such embodiment, the Level 1 consumer 218A is established as the originator of the consumer group 216, e.g., as an initial purchaser of available goods and/or services within the sales system 10. More specifically, a first consumer may make a purchase of a particular good or service that has been made available by a provider 14 to the sales system 10 (a “qualified purchase”), with the particular good or service being associated with a specific initializing code that can be registered with the system administrator 12 (illustrated in FIG. 1) or otherwise input into the sales system 10. The initializing code can be an alpha-numeric sequence, a bar code, a scanning code or any other suitable manner of identifying the good or service purchased and/or the identity of the first consumer. In one embodiment, the initializing code can be manually input by the consumer or another suitable person into the sales system 10. Alternatively, the initializing code can automatically be input into the sales system 10 during or after the qualified purchase. Upon receiving and/or registering the initialization code, the first consumer can then be officially registered as the Level 1 consumer 218A based upon such qualified purchase. In an alternative embodiment, the Level 1 consumer 218A may be established by receiving a specific initializing code that can be registered with the system administrator 12 or otherwise input into the sales system 10, without needing to make an actual purchase in order to receive the initializing code.

Subsequently, the initializing code, e.g., the code that relates to the initial purchase made by the Level 1 consumer 218A, can then be forwarded by the Level 1 consumer 218A to one or more additional individuals. In certain embodiments, these additional individuals can then use the initializing code to make their own qualified purchase within the bounds of the sales system 10 in order to validate the initializing code. In various alternative embodiments, the qualified purchase can be the same product or a different product than the initial purchase, and/or can be from the same or different provider 14). Upon making such a qualified purchase, and using the code for this purchase, these additional individuals can be identified as Level 2 consumers 218B. Alternatively, the Level 2 consumers 218B may be established by registering the initializing code with the system administrator 12 or otherwise inputting the initializing code into the sales system 10, without making an actual purchase in order to validate the initializing code.

One or more of these Level 2 consumers 218B can then forward the initializing code (or another associated code) to still more individuals, who can then use that code to become Level 3 consumers 218C, e.g., by making their own qualified purchases or by otherwise registering the initializing code (or another associated code) with the system administrator 12 and/or otherwise inputting the initializing code (or another associated code) within the sales system 10. This general process can be repeated such that additional levels of consumers are then established, i.e. Level 4 consumers 218D, Level 5 consumers 218E, etc. up to and including Level n consumers 218n.

In another embodiment, the individual consumers are assigned to different levels within the consumer group 216 depending on when (i.e. time-based) they entered the consumer group 216. In such embodiment, the Level 1 consumer 218A (or consumers) is established as an originator of the consumer group 216, e.g., as an initial consumer (or consumers) of available goods and/or services within the sales system 10 (illustrated in FIG. 1), in a given initial time period. Similar to the previous embodiment, a first consumer may make a purchase of a particular good or service that has been made available to the sales system 10 by a provider 14, with the particular good or service being associated with a specific initializing code that can be input into the sales system 10. As such, the first consumer can then be officially registered or identified as the Level 1 consumer 218A. Alternatively, the Level 1 consumer 218A may be established or identified by receiving a specific initializing code that can be registered with the system administrator 12 or otherwise input into the sales system 10, without needing to make an actual purchase in order to receive the initializing code.

Subsequently, the initializing code, e.g., the specific code that relates to the initial purchase, can then be forwarded by the Level 1 consumer 218A to one or more additional individuals. These additional individuals can then use the initializing code to make their own qualified purchase or to otherwise register the initializing code within the bounds of the sales system 10. However, instead of such subsequent qualified purchases or registering of the initializing code automatically establishing these additional individuals as Level 2 consumers 218B, the identification of these additional members can be based on when they entered into the sales system 10 by making such a qualified purchase or registering of the initializing code. For example, if the subsequent qualifying purchase is made within one day of the initial purchase by the initial Level 1 consumer 218A, then such additional consumers can also be identified as Level 1 consumers 218A. Additionally, as the initializing code from the initial purchase (or any associated code based on subsequent purchases) is forwarded to others by the initial Level 1 consumer 218A or any subsequent members of the consumer group 216, any such additional individuals may also be entered as specific level consumers based on when they made a qualifying purchase or otherwise registered the initializing code to enable their formal entry into the consumer group 216.

For example, in one non-exclusive embodiment, (i) any subsequent qualified purchase made within one day of the initial purchase by the initial Level 1 consumer 218A can result in such additional consumers also being identified as Level 1 consumers 218A; (ii) any subsequent qualified purchase made within one week of the initial purchase by the initial Level 1 consumer 218A can result in such additional consumers being identified as Level 2 consumers 218B; (iii) any subsequent qualified purchase made within one month of the initial purchase by the initial Level 1 consumer 218A can result in such additional consumers being identified as Level 3 consumers 218C; (iv) any subsequent qualified purchase made within two months of the initial purchase by the initial Level 1 consumer 218A can result in such additional consumers being identified as Level 4 consumers 218D; (v) any subsequent qualified purchase made within four months of the initial purchase by the initial Level 1 consumer 218A can result in such additional consumers being identified as Level 5 consumers 218E; or any other suitable time frames can be used to identify particular consumers as specific level consumers.

It should be noted that in this embodiment, the number of consumers included within any given level can be limited as desired within the terms of the sales system 10.

In still another embodiment, the individual consumers are assigned to different levels within the consumer group 216 depending on when (i.e. number-based or order-based) they entered the consumer group 216. In such embodiment, the Level 1 consumer 218A (or consumers) is established as an originator of the consumer group 216, e.g., as an initial consumer (or consumers) of available goods and/or services within the sales system 10 (illustrated in FIG. 1). Again, similar to the previous embodiments, a first consumer may make a purchase of a particular good or service that has been made available to the sales system 10 by the providers 14, with the particular good or service being associated with a specific initializing code that can be input into the sales system 10. As such, the first consumer can then be officially registered or identified as a Level 1 consumer 218A. Alternatively, the Level 1 consumer 218A may be established or identified by receiving a specific initializing code that can be registered with the system administrator 12 or otherwise input into the sales system 10, without needing to make an actual purchase in order to receive the initializing code.

Subsequently, the initializing code, e.g., the code that relates to the initial purchase, can then be forwarded by the Level 1 consumer 218A to one or more additional individuals. These additional individuals can then use the initializing code to make their own qualified purchase or to otherwise register the initializing code within the bounds of the sales system 10. However, in this embodiment, the identification of these additional members can be based on the order in which they entered into the sales system 10 by making such a qualified purchase or registering of the initializing code. As with the previous embodiment, this relates to any such additional members regardless of how they got invited into the sales system 10. For example, in one non-exclusive embodiment, after the initial consumer is established or identified as the Level 1 consumer 218A, (i) the next 10 additional individuals who make a qualified purchase within the sales system can be identified as Level 1 consumers 218A; (ii) the next 100 additional individuals after that who make a qualified purchase within the sales system can be identified as Level 2 consumers 218B; (iii) the next 250 additional individuals after that who make a qualified purchase within the sales system can be identified as Level 3 consumers 218C; (iv) the next 500 additional individuals after that who make a qualified purchase within the sales system can be identified as Level 4 consumers 218D; (v) the next 1000 additional individuals after that who make a qualified purchase within the sales system can be identified as Level 5 consumers 218E; or any other suitable numerical divisions can be used to label particular consumers as specific level consumers.

As noted above, the specific examples provided herein are only provided for ease of understanding, and such examples are not intended to be limiting in any manner. As such, it is recognized that an infinite number of possible hierarchy identifying (level identifying) protocols may be utilized that demonstrate and/or utilize the features of the present invention.

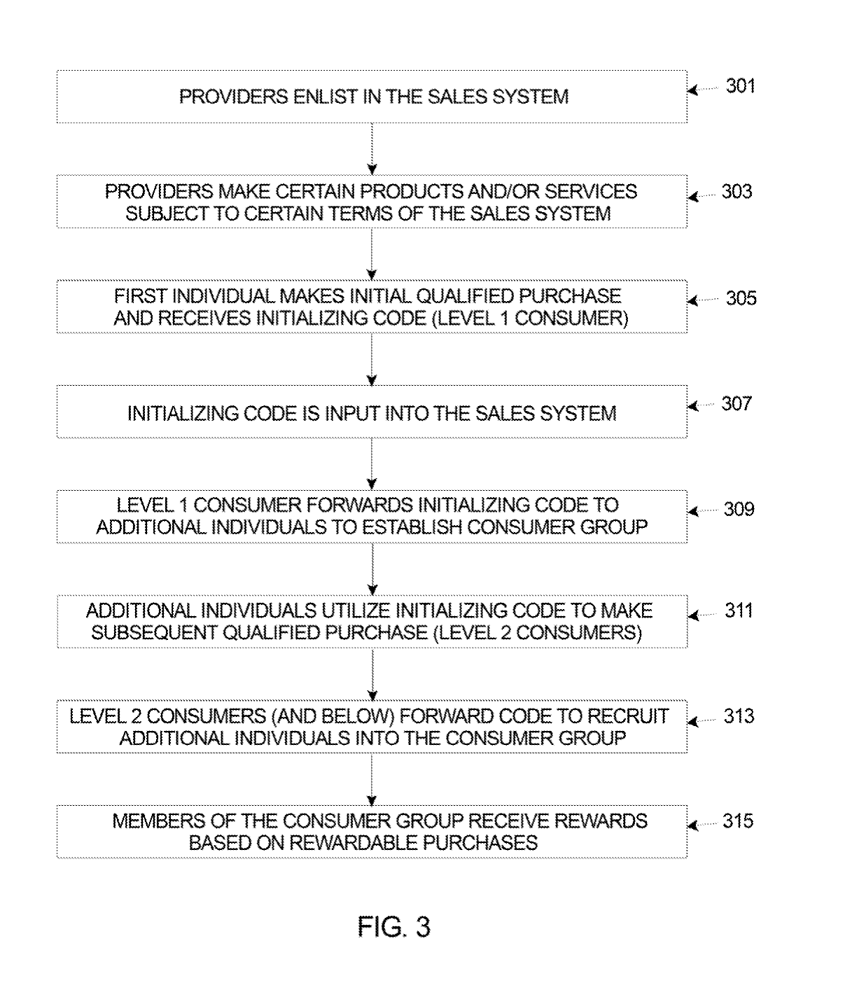

FIG. 3 is a flow chart illustrating the operation of one embodiment of the sales system 10. Initially, in step 301, one or more providers are recruited to enlist and/or otherwise enlist within the sales system. In step 303, each of the one or more providers that are enlisted in the sales system determines what products and/or services they offer that they desire to have subject to one or more of the various terms of the sales system. For example, as noted above, each of the providers can choose to make some or all of their products and/or services available for purchase through the sales system. Additionally, the providers can choose to make some or all of their products and/or services subject to one or more of the various terms incorporated within the sales system. For example, the providers can choose to make some or all of their products and/or services available for purchase through the sales system in order to (i) enable a given consumer to formally enter and become a member of a consumer group, (ii) enable members of a consumer group to receive specified price discounts via the terms of the sales system, (iii) enable members of a consumer group to receive specified rebates via the terms of the sales system, and/or (iv) enable the members of a consumer group to receive other specified rewards or benefits associated with the sales system.

In step 305, an initial or first consumer makes an initial purchase (i.e. a qualified purchase) of a particular good or service that is subject to the terms of the sales system. In one embodiment, the particular good or service can be associated with a specific code (i.e. an initializing code). In an alternative embodiment, the “first consumer” can receive the initializing code without the need for actually making a qualified purchase.

In step 307, the initializing code received by the first consumer is manually or automatically input into the sales system, such as an online system or other appropriate system, or otherwise registered with the sales administrator. The first consumer can thus be identified as a “Level 1 consumer”. During this process, certain information of the first consumer can also be input, and an online account (or other suitable account) can be established for the first consumer, although this step is not essential to the operation of the invention.

In step 309, the Level 1 consumer can establish and/or develop a consumer group by forwarding the initializing code received by the Level 1 consumer to one or more additional individuals. For example, in one embodiment, the initializing code can be forwarded to one or more of the Level 1 consumer's address book contacts, or any other contacts, using a conventional online address book program or a social networking program, as non-exclusive examples. Alternatively, any method for the Level 1 consumer to disseminate, provide or otherwise distribute the initializing code to other persons may be utilized.

In step 311, one or more of the additional individuals to whom the initializing code has been forwarded can utilize the initializing code to make a subsequent purchase of a particular good or service that is subject to the terms of the sales system (also referred to herein as a “subsequent qualified purchase”). By making such a subsequent qualified purchase, these additional individuals can be formally entered into or registered with the Level 1 consumer's consumer group, and, thus, be identified as “Level 2 consumers”. Alternatively, the additional individuals can register the initializing code with the system administrator or input the initializing code into the sales system without the need for a subsequent qualified purchase, and still be established as a Level 2 consumer.

In a somewhat similar manner, in step 313, any Level 2 consumer can also, in turn, provide the initializing code (or another associated code) to one or more additional individuals, e.g., to one or more of that Level 2 consumer's contacts. Any such additional individuals who receive and utilize the initializing code (or other associated code) to make a similar subsequent qualified purchase, can be formally entered into or registered with the Level 1 consumer's consumer group, and, thus, be identified as “Level 3 consumers”. Alternatively, the additional individuals can register the initializing code (or other associated code) with the system administrator or input the initializing code into the sales system without the need for a subsequent qualified purchase, and still be established as a Level 3 consumer.

Steps substantially similar to step 313 can further be undertaken as an additional means to expand the scope of the Level 1 consumer's consumer group. Stated in another fashion, step 313 can essentially be repeated as desired to further expand the Level 1 consumer's consumer group to additional levels. For example, (i) any Level 3 consumer can forward the initializing code (or other associated code) to one or more of their contacts to effectively recruit additional members to the consumer group as Level 4 consumers (i.e. upon utilizing the initializing code (or other associated code) to make a similar subsequent qualified purchase or otherwise inputting the initializing code (or other associated code) into the sales system); and (ii) any Level 4 consumer can forward the initializing code (or other associated code) to one or more of their contacts to effectively recruit additional members to the consumer group as Level 5 consumers (i.e. upon utilizing the initializing code (or other associated code) to make a similar subsequent qualified purchase or otherwise inputting the initializing code (or other associated code) into the sales system). It should be noted that the expansion of the Level 1 consumer's consumer group can continue in a similar manner so that the Level 1 consumer's consumer group includes any suitable number of levels.

As described, in one embodiment, the Level 1 consumer's consumer group can include one or more individuals within any subsequent levels within the Level 1 consumer's consumer group. However, it should be noted that the number of individuals in any given level and/or the total number of individuals within any given consumer group can be limited as desired based on the specific terms of the sales system within deviating from the intended scope and breadth of the present invention.

In step 315, members of the Level 1 consumer's consumer group, including the Level 1 consumer himself or herself, can make additional purchases of available goods and/or services through the sales system, i.e. as monitored by the sales administrator. Stated in another fashion, members of the Level 1 consumer's consumer group can make any number of rewardable purchases of available goods and/or services through the sales system. Based on the rewardable purchases, the members of the Level 1 consumer's consumer group can receive certain specified rewards (price discounts, rebates, etc.) In different embodiments, as noted above, the specific rewards being offered can be based, at least in part, on one or more of the number of members in the consumer group, the number of purchases made by the consumer group, and/or the sales volume, i.e. dollar value, of the purchases made by the consumer group. Additionally and/or alternatively, such specified benefits can also be based on other relevant factors related to the consumers, the consumer group, and/or the providers.

In one embodiment, depending upon the number of members in the Level 1 consumer's consumer group, a certain price discount can be applied to some or all of the rewardable purchases made by any members of the Level 1 consumer's consumer group. As one non-exclusive example, if the total number of members in the Level 1 consumer's consumer group is greater than 5, a 5% discount is applied to all rewardable purchases made by any members of the Level 1 consumer's consumer group. If the total number of members in the Level 1 consumer's consumer group is greater than 10, a 10% discount is applied to all rewardable purchases made by any members of the Level 1 consumer's consumer group. If the total number of members in the Level 1 consumer's consumer group is greater than 15, a 15% discount is applied to all rewardable purchases made by any members of the Level 1 consumer's consumer group. If the total number of members in the Level 1 consumer's consumer group is greater than 20, a 20% discount is applied to all rewardable purchases made by any members of the Level 1 consumer's consumer group, etc. In one embodiment, there can be a maximum discount that is applied, such as 25% for any number of members in the Level 1 consumer's consumer group greater than 25, for example.

In another embodiment, the members of the Level 1 consumer's consumer group can receive a specific percentage discount based on the total dollar value of all of the purchases made by members of the Level 1 consumer's consumer group, with the specific percentage varying depending upon the total amount of all of the purchases made by members of the Level 1 consumer's consumer group. For example, if the total amount of the purchases by all of the members in the Level 1 consumer's consumer group is less than $1,000.00 over a particular time period, a 5% discount may be applied to all rewardable purchases made by any members of the Level 1 consumer's consumer group. If the total amount of the purchases by all of the members in the Level 1 consumer's consumer group is between $1,000.00 and $5,000.00 over that particular time period, a 10% discount may be applied to all rewardable purchases made by any members of the Level 1 consumer's consumer group. If the total amount of the purchases by all of the members in the Level 1 consumer's consumer group is between $5,000.00 and $10,000.00 over that particular time period, a 15% discount may be applied to all rewardable purchases made by any members of the Level 1 consumer's consumer group, or any other suitable discount percentages can be used.

It should be noted that in various embodiments, the rewardable purchases made that are subject to any offered discount percentage may be limited such that such purchases can only be from a specified list of goods and/or services. Alternatively, the rewardable purchases made that are subject to a discount percentage can be unlimited or unrestricted and can include any goods or services.

Additionally, in one embodiment, the Level 1 consumer can also receive a percentage of the overall purchase amount by all of the members in the Level 1 consumer's consumer group, which may or may not be dependent upon the total amount of the purchases. For example, in one embodiment, the Level 1 consumer can periodically receive 5% of the dollar amount of the overall purchases by all of the members in the Level 1 consumer's consumer group regardless of the total amount of the purchases. Moreover, such percentage of the overall purchase amount by the members in the Level 1 consumer's consumer group may be evaluated and awarded on a specified periodic basis, such as each week, each month, every two months, every three months (i.e. quarterly), every six months (i.e. semi-annually), every year (i.e. annually), or some other specified period.

In another embodiment, the Level 1 consumer can receive a specific percentage rebate of the total amount, e.g. dollar value, of all of the purchases made by members of the Level 1 consumer's consumer group, with the specific percentage varying depending upon the total amount of all of the purchases made by members of the Level consumer's consumer group. For example, if the total amount of the purchases by all of the members in the Level 1 consumer's consumer group is less than $1,000.00 over a particular time period, the Level 1 consumer may receive a 2% rebate of that total amount for that particular time period. If the total amount of the purchases by all of the members in the Level 1 consumer's consumer group is between $1,000.00 and $10,000.00 over that particular time period, the Level 1 consumer may receive a 5% rebate of that amount for that particular time period. If the total amount of the purchases by all of the members in the Level 1 consumer's consumer group is between $10,000.00 and $100.000.00 over that particular time period, the Level 1 consumer may receive a 10% rebate of that amount for that particular time period, or any other suitable rebate percentages can be used.

In one embodiment, the rebate can be received from one or more manufacturers of goods and/or providers of services that agree to participate in the above structured program, i.e. from one or more providers. Moreover, such percentage rebate of the total amount of all purchases by the members of the Level 1 consumer's consumer group may be evaluated and awarded on a specified periodic basis, such as each week, each month, every two months, every three months (i.e. quarterly), every six months (i.e. semi-annually), every year (i.e. annually), or some other specified period.

In yet another embodiment, the Level 1 consumer can receive a specific percentage rebate of the total amount, e.g. dollar value, of all of the purchases by that Level 1 consumer's consumer group, with the specific percentage varying depending upon the number of members in the Level 1 consumer's consumer group. For example, if the total number of members in the Level 1 consumer's consumer group is between 10 and 50, that Level 1 consumer may receive a 2% rebate of that total amount of the purchases made by members of the Level 1 consumer's consumer group. If the total number of members in the Level 1 consumer's consumer group is between 50 and 100, the Level 1 consumer may receive a 5% rebate. If the total number of members in the Level 1 consumer's consumer group is between 100 and 500, the Level 1 consumer may receive a 10% rebate, or any other suitable discount percentages can be used. Moreover, such percentage rebate of the total amount of all purchases made by members of the Level 1 consumer's consumer group may be evaluated and awarded on a specified periodic basis, such as each week, each month, every two months, every three months (i.e. quarterly), every six months (i.e. semi-annually), every year (i.e. annually), or some other specified period.

In certain alternative embodiments, any Level 2 consumer, any Level 3 consumer, etc. (a “lower level consumer”) may choose to in effect become a Level 1 consumer by providing one or more individuals e.g., contacts, with an alternative initializing code that the lower level consumer obtained from a subsequent qualified purchase made by that lower level consumer. In one such embodiment, all of the individuals that utilize the alternative initializing code provided by the lower level consumer would become part of the lower level consumer's new consumer group, thereby beginning a new numerical count of members in the lower level consumer's consumer group. The various reward levels as described above, for example, would be dependent upon the number of members in the lower level consumer's new consumer group, and would be independent from the previous Level 1 consumer's consumer group. Essentially, the lower level consumer would have initiated his or her own new consumer group, and would no longer be associated with the previous Level 1 consumer's consumer group. Stated in another fashion, in certain embodiments, each individual consumer can only be a member of a single consumer group at any given time. Moreover, in such embodiments, once any individual member registers as a member in a new consumer group, such individual member is no longer a member of the original consumer group. In one such embodiment, the Level 1 consumer would have lost one or more members from that Level 1 consumer's consumer group, depending on how many Level 2, Level 3, etc. consumers from the Level 1 consumer's consumer group decide to initiate their own consumer group, and/or depending on how many Level 3, Level 4, etc. consumers from the Level 1 consumer's consumer group decide to move to the new consumer group. It is recognized that the changing of the numbers in the Level 1 consumer's consumer group could potentially impact either or both of (1) the percentage discount that is applied to all purchases made by the Level 1 consumer's consumer group, and (2) the rebate that would be received by the Level 1 consumer.

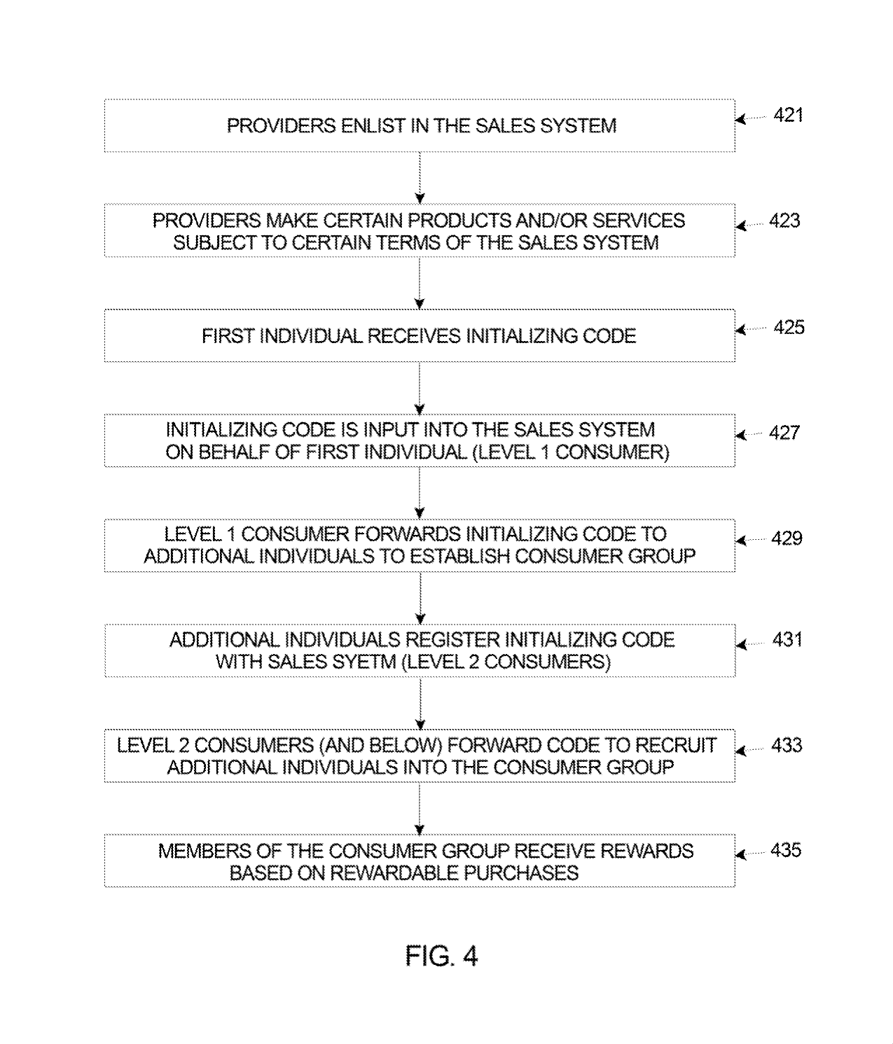

FIG. 4 is a flow chart illustrating the operation of another embodiment of the sales system 10. The embodiment illustrated and described in relation to FIG. 4 is somewhat similar to the embodiment illustrated and described above in relation to FIG. 3. Initially, in step 421, one or more providers are recruited to enlist and/or otherwise enlist within the sales system. In step 423, similar to the previous embodiment, each of the one or more providers that are enlisted in the sales system determines what products and/or services they offer that they desire to have subject to one or more of the various terms of the sales system.

In step 425, an initial or first consumer receives an initializing code. In step 427, the initializing code received by the first consumer is manually or automatically input into the sales system, or otherwise registered with the sales administrator. The first consumer can thus be identified as a “level 1 consumer”.

In step 429, the Level 1 consumer can establish and/or develop a consumer group by forwarding the initializing code received by the Level 1 consumer to one or more additional individuals, e.g., to one or more of that Level 1 consumer's contacts.

In step 431, one or more of the additional individuals to whom the initializing code has been forwarded can register the initializing code with the system administrator or otherwise input the initializing code into the sales system, and thus be established as a Level 2 consumer within the Level 1 consumer's consumer group.

In a somewhat similar manner, in step 433, any Level 2 consumer can also, in turn, provide the initializing code (or another associated code) to one or more additional individuals, e.g., to one or more of that Level 2 consumer's contacts. Any such additional individuals who receive the initializing code (or other associated code) can register the initialization code (or another associated code) with the system administrator or otherwise input the initializing code into the sales system, and thus be established as a Level 3 consumer within the Level 1 consumer's consumer group.

Steps substantially similar to step 433 can further be undertaken as an additional means to expand the scope of the Level 1 consumer's consumer group. Stated in another fashion, step 433 can essentially be repeated as desired to further expand the Level 1 consumer's consumer group to additional levels. For example, (i) any Level 3 consumer can forward the initializing code (or other associated code) to one or more of their contacts to effectively recruit additional members to the consumer group as Level 4 consumers (i.e. upon registering the initializing code (or other associated code) into the sales system); and (ii) any Level 4 consumer can forward the initializing code (or other associated code) to one or more of their contacts to effectively recruit additional members to the consumer group as Level 5 consumers (i.e. upon registering the initializing code (or other associated code) into the sales system). It should be noted that the expansion of the Level 1 consumer's consumer group can continue in a similar manner so that the Level 1 consumer's consumer group includes any suitable number of levels.

In step 435, members of the Level 1 consumer's consumer group, including the Level 1 consumer himself or herself, can make purchases of available goods and/or services through the sales system, i.e. as monitored by the sales administrator. Stated in another fashion, members of the Level 1 consumer's consumer group can make any number of rewardable purchases of available goods and/or services through the sales system. Based on the rewardable purchases, the members of the Level 1 consumer's consumer group can receive certain specified rewards (price discounts, rebates, etc.). In different embodiments, as noted above, the specific rewards being offered can be based, at least in part, on one or more of the number of members in the consumer group, the number of purchases made by the consumer group, and/or the sales volume, i.e. dollar value, of the purchases made by the consumer group. Additionally and/or alternatively, such specified benefits can also be based on other relevant factors related to the consumers, the consumer group, and/or the providers.

It should be noted that one or more of the embodiments of the sales system 10 described herein can be combined as desired to form still yet other embodiments of sales systems 10 having features of the present invention. Additionally, it should further be noted that the order of the steps illustrated and described in FIGS. 3 and 4 is not necessarily indicative of how the sales system 10 operates chronologically, as one or more of the steps can be combined, reordered, and/or performed simultaneously without deviating from the intended breadth and scope of the sales system 10.

While a number of exemplary aspects and embodiments of a sales system 10 and method for coordinating purchases of goods and/or services have been discussed above, those of skill in the art will recognize certain modifications, permutations, additions and sub-combinations thereof. It is also understood that various components or steps from the various embodiments can be combined without deviating from the scope of the present invention. It is therefore intended that the following appended claims and claims hereafter introduced are interpreted to include all such modifications, permutations, additions and sub-combinations as are within their true spirit and scope.

1. A method for coordinating purchases of goods or services, the method comprising the steps of:
establishing a consumer group including a plurality of members; and
establishing a first price discount on a first consumable that is made available to each of the plurality of members of the consumer group, the first price discount being based on the number of members in the consumer group, the first price discount being made available to each of the plurality of members of the consumer group regardless of the number of members that actually purchase the first consumable.

2. (canceled)

3. The method of claim 1 further comprising the step of applying the first price discount to a rewardable purchase of the first consumable made by a first member.

4. The method of claim 1 further comprising the step of establishing a second price discount on a second consumable that is made available to a first member of the consumer group, wherein the second price discount on the second consumable is not made available to a second member of the consumer group.

5. The method of claim 1 further comprising the step of providing a rebate to the first member of the consumer group, the rebate being based upon a dollar amount of purchases made by one or more members of the consumer group over a predetermined period of time.

6. The method of claim 1 further comprising the step of providing a rebate to the first member of the consumer group, the rebate being based upon a number of purchases made by one or more members of the consumer group over a predetermined period of time.

7. The method of claim 1 further comprising the step of providing a first rebate to the first member of the consumer group when any member of the consumer group makes a first rewardable purchase.

8. The method of claim 7 further comprising the step of providing a second rebate to the first member of the consumer group when any member of the consumer group makes a second rewardable purchase.

9. The method of claim 1 wherein the step of establishing a consumer group includes the step of a first member originating the consumer group by making a first qualified purchase.

10. The method of claim 9 wherein the step of establishing a consumer group further includes the step of adding a second member to the consumer group when the second member makes a second qualified purchase.

11. The method of claim 1 wherein the step of establishing a consumer group includes the step of a first member originating the consumer group by registering an initialization code with a system administrator.

12. The method of claim 11 wherein the step of establishing a consumer group includes the first member receiving the initialization code when the first member makes a qualified purchase.

13. The method of claim 11 wherein the step of establishing a consumer group further includes the step of adding a second member to the consumer group when the second member registers the initialization code with the system administrator.

14. The method of claim 11 wherein the step of establishing a consumer group further includes the step of adding a second member to the consumer group when the second member receives the initialization code from the first member and registers an associated code with the system administrator, the associated code being associated with the initialization code.

15. A method for coordinating purchases of goods or services, the method comprising the steps of:
establishing a consumer group including at least a first member and a second member, the consumer group being established by (i) the first member registering an initializing code with a system administrator, (ii) the second member receiving the initialization code from the first member, and (ii) the second member registering the initialization code with the system administrator; and
establishing a price discount on a first, consumable that is, made available to the first member and the second member of the consumer group, the price discount being based on the number of members in the consumer group, the price discount being made available to the first member and the second member of the consumer group regardless of the number of members that actually purchase the first consumable.

16. (canceled)

17. The method of claim 15 further comprising the step of applying the price discount to a rewardable purchase of the first consumable made by at least one of the first member and the second member.

18. The method of claim 15 further comprising the step of providing a rebate to the first member of the consumer group, the rebate being based on a dollar amount of rewardable purchases made by one or more members of the consumer group over a predetermined period of time.

19. The method of claim 15 further comprising the step of providing a rebate to the first member of the consumer group, the rebate being based on a number of rewardable purchases made by one or more members of the consumer group over a predetermined period of time.

20. The method of claim 15 further comprising the step of providing a first rebate to the first member of the consumer group when any member of the consumer group makes a first rewardable purchase.

21. The method of claim 15 wherein the step of establishing a consumer group includes the first member receiving the initialization code by making a first qualified purchase.

22. The method of claim 21 wherein the step of establishing a consumer group includes the second member registering the initialization code when the second member makes a second qualified purchase.

23. A method for coordinating purchases of goods or services, the method comprising the steps of:
establishing a consumer group including at least a first member and a second member, the consumer group being established by (i) the first member making a qualified purchase, and (ii) the second member making a subsequent qualified purchase; and
establishing a price discount on a first consumable that is made available to the first member and the second member of the consumer group, the price discount being based on the number of members in the consumer group, the first price discount being made available to the first member and the second member of the consumer group regardless of the number of members that actually purchase the first consumable.

24. (canceled)

25. The method of claim 23 further comprising the step of applying the price discount to a rewardable purchase of the first consumable made by at least one of the first member and the second member.

26. The method of claim 23 further comprising the step of providing a rebate to the first member of the consumer group, the rebate being based on a dollar amount of rewardable purchases made by one or more members of the consumer group over a predetermined period of time.

27. The method of claim 23 further comprising the step of providing a rebate to the first member of the consumer group, the rebate being based on a number of rewardable purchases made by one or more members of the consumer group over a predetermined period of time.

28. The method of claim 23 further comprising the step of providing a first rebate to the first member of the consumer group when any member of the consumer group makes a first rewardable purchase.

29. A sales system for coordinating purchases of goods or services, the sales system comprising:
a consumer group including a plurality of members; and
a system administrator that coordinates the purchases of goods and services for the consumer group, the system administrator establishing a first price discount on a first consumable that is made available to each of the plurality of members of the consumer group, the first price discount being based on the number of members in the consumer group, the first price discount being made available to each of the plurality of members of the consumer group regardless of the number of members that actually purchase the first consumable.

30. (canceled)

31. The sales system of claim 29 wherein the system administrator applies the first price discount to a rewardable purchase of the first consumable made by a first member.

32. The sales system of claim 29 wherein the system administrator establishes a second price discount on a second consumable that is made available to a first member of the consumer group, wherein the second price discount on the second consumable is not made available to a second member of the consumer group.

33. The sales system of claim 29 further comprising a provider that makes the first consumable available to the plurality of members of the consumer group.

34. The sales system of claim 29 wherein the system administrator provides a rebate to a first member of the consumer group, the rebate being based upon a dollar amount of purchases made by one or more members of the consumer group over a predetermined period of time.

35. The sales system of claim 29 wherein the system administrator provides a rebate to a first member of the consumer group, the rebate being based upon a number of purchases made by one or more members of the consumer group over a predetermined period of time.

36. The sales system of claim 29 wherein the system administrator provides a rebate to a first member of the consumer group when any member of the consumer group makes a rewardable purchase.

37. The sales system of claim 29 wherein the consumer group is originated by a first member that makes a first qualified purchase.

38. The sales system of claim 37 wherein the consumer group adds a second member when the second member makes a second qualified purchase.

39. The sales system of claim 29 wherein the consumer group is originated by a first member that registers an initialization code with the system administrator.

40. The sales system of claim 39 wherein the first member receives the initialization code when the first member makes a qualified purchase.

41. The sales system of claim 39 wherein the consumer group adds a second member when the second member registers the initialization code with the system administrator.

42. The sales system of claim 39 wherein the consumer group adds a second member when the second member receives the initialization code from the first member and registers an associated code with the system administrator, the associated code being associated with the initialization code.

43. A sales system for coordinating purchases of goods or services, the sales system comprising:
a consumer group including at least a first member and a second member, the first member receiving an initialization code and forwarding the initialization code to the second member; and
a system administrator that coordinates the purchases of goods and services for the consumer group, the first member and the second member registering the initialization code with the system administrator, wherein the system administrator establishes a first price discount on a first consumable that is made available to each of the plurality of members of the consumer group, the first price discount being based on the number of members in the consumer group, the first price discount being made available to each of the plurality of members of the consumer group regardless of the number of members that actually purchase the first consumable.

44. (canceled)

45. The sales system of claim 43 wherein the system administrator applies the first price discount to a rewardable purchase of the first consumable made by at least one of the first member and the second member.

46. The sales system of claim 43 further comprising a provider that makes the first consumable available to the consumer group.

47. The sales system of claim 43 wherein the system administrator provides a rebate to the first member of the consumer group, the rebate being based upon a dollar amount of purchases made by one or more members of the consumer group over a predetermined period of time.

48. The sales system of claim 43 wherein the system administrator provides a rebate to the first member of the consumer group, the rebate being based upon a number of purchases made by one or more members of the consumer group over a predetermined period of time.

49. The sales system of claim 43 wherein the system administrator provides a rebate to the first member of the consumer group when any member of the consumer group makes a rewardable purchase.

50. The sales system of claim 43 wherein the first member receives the initialization code by making a first qualified purchase.

51. The sales system of claim 50 wherein the second member registers the initialization code when the second member makes a second qualified purchase.

52. A sales system for coordinating purchases of goods or services, the sales system comprising:
a consumer group including at least a first member and a second member, the consumer group being established by (i) the first member making a qualified purchase, and (ii) the second member making a subsequent qualified purchase; and
a system administrator that coordinates the purchases of goods and services for the consumer group, wherein the system administrator establishes a first price discount on a first consumable that is made available to each of the plurality of members of the consumer group, the first price discount being based on the number of members in the consumer group, the first price discount is made available to each of the plurality of members of the consumer group consumable.

53. (canceled)

54. The sales system of claim 52 wherein the system administrator applies the first price discount to a rewardable purchase of the first consumable made by at least one of the first member and the second member.

55. The sales system of claim 52 further comprising a provider that makes the first consumable available to the consumer group.

56. The sales system of claim 52 wherein the system administrator provides a rebate to the first member of the consumer group, the rebate being based upon a dollar amount of purchases made by one or more members of the consumer group over a predetermined period of time.

57. The sales system of claim 52 wherein the system administrator provides a rebate to the first member of the consumer group, the rebate being based upon a number of purchases made by one or more members of the consumer group over a predetermined period of time.

58. The sales system of claim 52 wherein the system administrator provides a rebate to the first member of the consumer group when any member of the consumer group makes a rewardable purchase.

59. The method of claim 1 wherein the step of establishing a first price discount includes the first price discount being the same for each of the plurality of members that purchase the first consumable.

60. The method of claim 15 wherein the step of establishing a price discount includes the price discount being the same for each of the members in the consumer group that purchase the first consumable.

61. The method of claim 23 wherein the step of establishing a price discount includes the price discount being the same for each of the members in the consumer group that purchase the first consumable.

62. The sales system of claim 29 wherein the first price discount is the same for each of the plurality of members that purchase the first consumable.

63. The sales system of claim 43 wherein the first price discount is the same for each of the members in the consumer group that purchase the first consumable.

64. The sales system of claim 52 wherein the first price discount is the same for each of the members in the consumer group that purchase the first consumable.
